(19) United States
(12) Patent Application Publication
(10) Pub. No.: US 2009/0063481 A1
(43) Pub. Date: Mar. 5, 2009

(54) SYSTEMS AND METHODS FOR DEVELOPING FEATURES FOR A PRODUCT

(76) Inventors: Norman L. Faus, Holly Springs, NC (US); Darryl L. Pierce, Apex, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 11/849,227

(22) Filed: Aug. 31, 2007

(51) Int. Cl. G06F 17/30

(52) U.S. Cl. 707/6; 707/E17.008

(57) ABSTRACT

An embodiment relates to a method for developing features for a product. The method includes monitoring a forum for messages and parsing a newly posted message in the forum. The method also includes determining whether the newly posted message contains a new feature comment and posting the new feature comment on a future feature list in response to the newly posted message contains a new feature comment.

### FIELD

This invention relates generally to products, more particularly, to systems and methods for developing features for a respective product.

### DESCRIPTION OF THE RELATED ART

The proliferation of the World Wide Web through the Internet has made a wealth of products and services available to users to purchase and use nearly instantaneously. Vendors, service providers, manufacturers, third party distributors, etc., may have web sites for the users to review and purchase their respective products and/or services.

The World Wide Web has also generated many message boards, usenet groups, forums, chat rooms, or other types of electronic discussion groups. to discuss a variety of topics. Many of the topics involve discussing pros and cons of a particular product (e.g., software application, hardware device, etc.). As the discussion grows regarding a selected product, a user community can form to resolve technical issues, discuss upcoming releases or versions, etc.

Since members of the user community have actually used the selected product, they are most familiar with the advantages and disadvantages of the selected product. Users may typically post complaints about the selected product in a discussion group. Many of the complaints or negative comments can be interpreted as a desired feature and/or requesting a bug fix, which are valid and solid criticisms of the selected product.

In order for users to inform the vendor of the selected product about bug fixes or desired features, a user would typically have to contact the help desk of the vendor to put in a request for the desired feature or bug fixes, which may take considerable amount of time. Often, the vendor has no incentive to quickly install the desired features or bug fixes until the next release, which can be an indeterminate length of time. Thus, there is a need in the art for a mechanism where users can direct desired features or bug fixes for a selected product to the vendor and for the vendor to deploy the those changes as quickly as possible.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts an exemplary system in accordance with an embodiment;

FIG. 2 illustrates an exemplary service portal of the system shown in FIG. 1 in accordance with another embodiment;

FIG. 3 depicts an exemplary feature module shown in FIG. 1 in accordance with yet another embodiment;

FIG. 4 illustrates an exemplary vendor notification page in accordance with yet another embodiment;

FIG. 5 depicts an exemplary flow diagram in accordance with yet another embodiment;

FIG. 6 depicts another exemplary flow diagram in accordance with yet another embodiment; and

FIG. 7 depicts an exemplary computing system in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of information and service portals, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments relate generally to systems and methods for developing a new feature list and offering bounties to develop features and/or bug fixes on the new feature list. More particularly, a feature module can be configured to monitor electronic discussion groups (e.g.,forums, message boards, chat rooms, etc.) on a web service portal. The web service portal, among other functions, can be configured to sell and support products and/or services (e.g., software products, hardware products, services, etc.). Each supported product can have an associated forum for the user community to discuss the product.

The feature module can then apply a key word search to the message posted in a forum related to a particular product to determine whether the posted message is directed toward a desired feature and/or bug fix related to the product. The key word search can be based on a dictionary of terms, which can be developed by the user community, vendors of the products, technical support staff or a combinations thereof. The feature module can then apply a natural language engine using latent semantic analysis or other natural language algorithms to extract a feature comment from the posted message. The feature module can then take the extracted feature comment and post the extracted feature comment as a desired feature on the new feature list. In some embodiments, the feature module can forward the extracted feature comment to a first available support staff for editing and/or approval to the new feature list.

The new or future feature list can then be made available to the respective vendor of the product by the feature module. More particularly, the feature module can maintain a graphical page (e.g., a web page) for the new feature list. The feature module can notify the vendor when new desired features are posted on the new feature list.

The vendor can be provided rewards for developing any feature listed on the future feature list by a web service portal that maintains the feature module. Alternatively, the vendor can contact the user or the user community to pay for a selected feature.

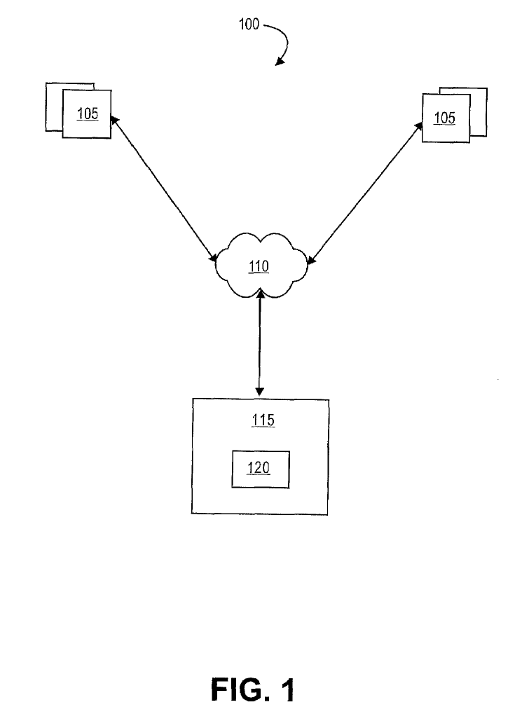

FIG. 1 illustrates an exemplary system 100 in accordance with an embodiment. It should be readily apparent to those of ordinary skill in the art that the system 100 depicted in FIG. 1 represents a generalized schematic illustration and that other components may be added or existing components may be removed or modified. Moreover, the system 100 may be implemented using software components, hardware components, or combinations thereof.

As shown in FIG. 1, the system 100 includes users 105, a network 110 and a web service portal 115. The users 105 can be private individuals, employees of private business or public entities or other persons interested in accessing the web service portal 115. The users 105 can access the web service portal 115 using personal computers, personal mobile devices, workstations or other networked computing platforms.

The network 110 can be a combination of wide area and local area networks such as the Internet. The network 110 can be configured to provide a communication channel between the users 105 and the web service portal 115. The network 110 can implement a variety of network protocols to provide the communication channel such as Internet Protocol (“IP”) Vx, ATM, SONET, or other similar network protocols.

The web service portal 115 can be configured to provide products and services to the user 105 as well as provisioning, installation services, updates to software and hardware products and technical support. The web service portal 115 can, among other functions, provide a list of products such as software applications and/or hardware devices as well as services such as installation, configuration, maintenance, etc., for users to purchase. As a non-limiting example, the web service portal 115 can also provide information for users to research, compare and purchase software, hardware and consulting services in support of those software and/or hardware purchases. The web service portal 115 can also be configured to provide support services by subscription to those same software, service, and/or hardware purchases.

In accordance with various embodiments, the web service portal 115 can be configured to provide a feature module 120 to develop new features and/or bug fixes for products being sold on the web service portal 115. More specifically, the feature module 120 can be configured to monitor electronic discussion groups (e.g.,forums, message boards, chat rooms, etc.) on the web service portal 115. The feature module 120 can then apply a key word search to a new message posted in electronic discussion group related to a particular product to determine whether the posted message is directed toward a desired feature and/or bug fix related to the product. The key word search can be based on a dictionary of terms, which can be developed by the user community, vendors of the products, technical support staff or a combinations thereof.

The feature module 120 can then apply a natural language engine using latent semantic analysis or other natural language algorithms to extract a feature comment from the posted message. The feature module can then take the extracted feature comment and post the extracted feature comment as a desired feature on the new feature list (not shown). In some embodiments, the feature module can forward the extracted feature comment to a first available support staff for editing and/or approval to the new feature list.

The feature module 120 can then post the feature comment as a desired feature or a bug fix on the new feature list. In some embodiments, the feature module 120 can forward the extracted feature comment to a first available support staff for editing and/or approval to the new feature list.

The new feature list can then be made available to the respective vendor of the product by the feature module. More particularly, the feature module 120 can maintain a graphical page (e.g., a web page) for the new feature list. The feature module 120 can notify the vendor when new desired features are posted on the new feature list.

The feature module 120 can be configured to provide rewards for the vendor to develop any feature listed on the new feature list. Alternatively, the vendor can contact the user or the user community to pay for a selected feature.

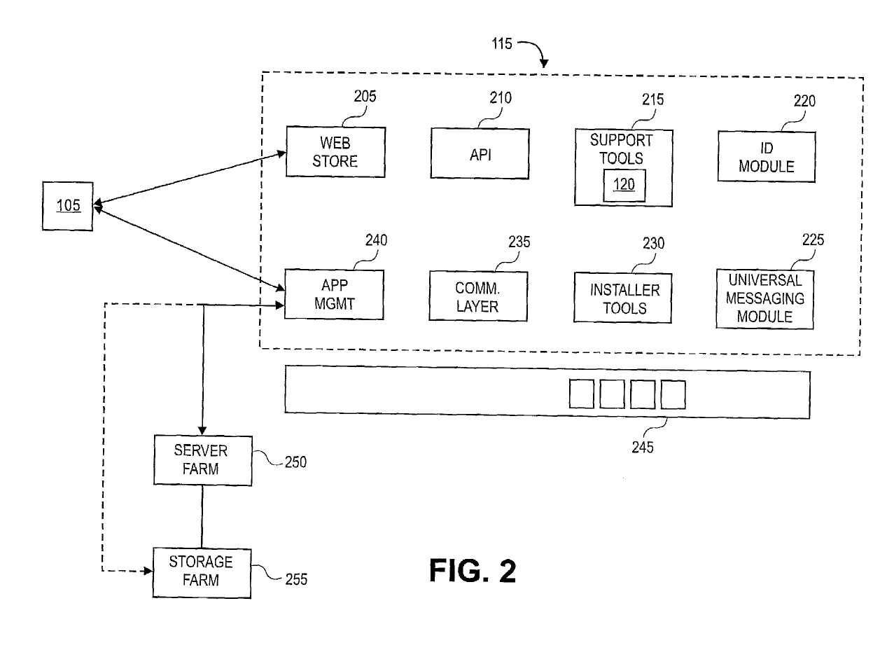

FIG. 2 illustrates a more detailed block diagram of the web service portal 115 in accordance with another embodiment. It should be readily apparent to those of ordinary skill in the art that the web service portal 115 depicted in FIG. 2 represents a generalized schematic illustration and that other components may be added or existing components may be removed or modified.

As shown in FIG. 2, the web service portal 115 can include a web store module 205 that a user can interface with the service portal. The web store module 205 can provide the graphical user interfaces (“GUIs”) and associated functions and/or services for the web service portal 115. As a non-limiting example, the web store module 205 can generate a log-in GUI for a user to authenticate and enter the web service portal 115.

The web store module 205 can couple with an application program interface (“API”) module 210. The API module 210 can be configured to provide an interface between the functions and/or services provided by the web store module 205 and to the appropriate module of the web service portal 115. More particularly, the API module 210 can call or direct a requested function or service from the user to the respective module that provides that requested function or service. For example, a user may request a price of a product, e.g., an electronic mail program, the API module 210 can direct the request to a get price function in a support tools module 215.

The API module 210 can also be configured to interface with the support tools module 215. The support tools module 215 can be configured to provide the supporting software and hardware to implement the functionality of the web service portal 115. The support tools module 215 can contain and provide access to databases that contain information such as products lines, services providers, on-line self-help (e.g., knowledgebase), etc. The support tools module 215 can also provide services like a chat services, a help desk, installation, provisioning, etc.

The API module 210 can be further configured to couple with an identification (“ID”) module 220. The ID module 220 can be configured to provide identification management services for the web service portal 115. The ID module 220 can also store information related to users such as purchase history, user profile, usage history of the user, and entitlement data.

The API module 210 can be further configured to couple with a universal messaging module 225. The universal messaging module 225 can be configured to provide a messaging application that unifies messages. More specifically, electronic mail (“email”), documents, and instant messaging can be linked in a single application. The universal messaging module 225 can also provide a mechanism for a user to view all the related documents for the user from email to Wiki pages.

An installer tools 230 can be coupled to the API module 210. One of the services provided by the web service portal 115 can be the purchase of software applications provided by independent software vendors (“ISVs”). As part of the delivery of the software applications, the ISV can be required to maintain and update the installation tools to install their respective software applications. Accordingly, the installer tools 230 can be a repository where independent software vendors can deposit their respective installation tools.

The API module 210 can be further coupled to the communication layer 235 (labeled as COMM layer in FIG. 2). The communication layer 235 can be configured to provide the underlying services for the modules of the web service portal 115 to communicate. For example, the communication layer 235 can contain middleware for a product database to communicate with a graphical user interface requesting product description.

The API module 210 can be further coupled to an application management module 240 (labeled as APP MGMT in FIG. 2). The application management module 240 can be configured to manage applications as requested by users. More specifically, a user may purchase a prepackaged software application pack (e.g., an operating system, electronic mail program and data mining program) from the web service portal 115, which is stored in an application stack module 245. The application management module 240 can then deliver the purchased software stack, install and configure the software application stack at a third party site such as server farm 250 or store the software application stack in a storage farm 255 for the user to retrieve.

The server farm 250 can be configured to provide computing platforms for users to lease. Accordingly, users can have a backup version of their systems, a testing platform to perform quality assurance tests on new applications, execute a program requiring excessive MIPS, or any other similar computing task.

The storage farm 255 can be configured to provide storage space for users to lease. Accordingly, users can lease disk storage space to back up data, provide a hot data swap, or other storage intensive tasks.

In some embodiments, the feature module 120 can be configured to be executed in the support tools module 215. In other embodiments, the feature module 120 can be a module of the ID module 220. In yet other embodiments, the feature module 120 can be executed as a standalone module.

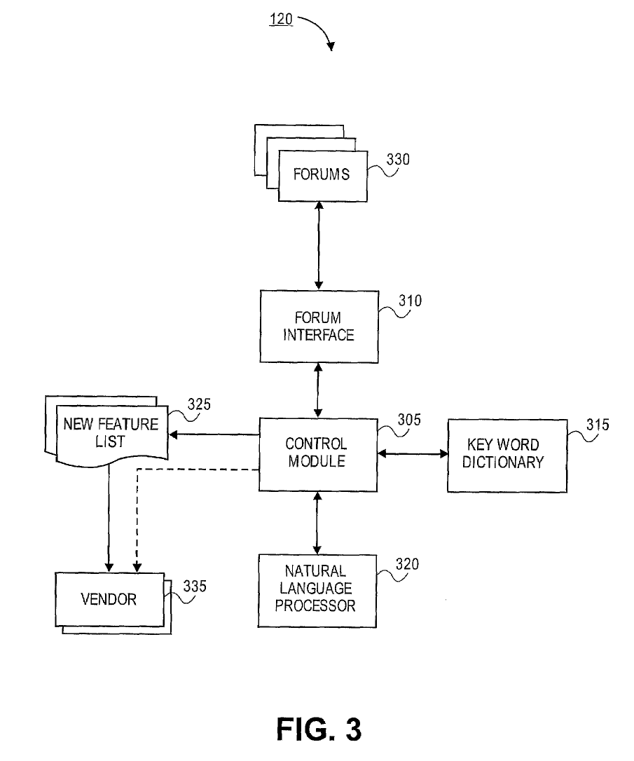

FIG. 3 depicts a more detailed block diagram of the feature module 120 in accordance with another embodiment. It should be readily apparent to those of ordinary skill in the art that the feature module 120 depicted in FIG. 3 represents a generalized schematic illustration and that other components may be added or existing components may be removed or modified.

As shown in FIG. 3, the feature module 120 can comprise a control module 305, a forum interface 310, a key word dictionary 315, a natural language processor 320, a new feature list 325. It should be readily obvious to one of ordinary skill in the art that the modules 305-325 can be implemented as software applications (programmed in C, C++, JAVA, PHP, etc.), hardware components (EEPROM, application specific integrated circuit, microprocessor, etc.) or combinations thereof.

The control module 305 can be configured to manage and interface with the other modules 310-325 to provide the functionality of the feature module 120 as described above and further described herein below.

The control module 305 can be coupled to the forum interface 310. The forum interface 310 can be configured to couple with a forum(s) 330 (or other electronic discussion groups) to monitor for posted messages by users. The forum interface 310 can also be configured to retrieve a copy of the posted message from the forum(s) 330. In some embodiments, the forum(s) 330 can be configured to automatically forward posted messages to the control module 305. The forum interface 310 can be implemented as a remote procedure call, an application program interface, as part of a middleware for messaging processing between the modules of the web service portal 115 or other similar techniques.

The forums 330 can be a part of a knowledgebase of the web-service portal 115. User can search, post questions and answers in the forums 330 to resolve technical issues or debate the merits of a particular product. Each forum 330 can be associated with a particular topic (e.g., a product).

Forum software packages are widely available on the Internet and are written in a variety of programming languages, such as PHP, Perl, Java, and ASP. The configuration and records of posts can be stored in text files or in a database. Each package offers different features, from the most basic, providing text-only postings, to more advanced packages, offering multimedia support and formatting code (usually known as BBCode). Many packages can be integrated easily into an existing website to allow visitors to post comments on articles.

The control module 305 can be further coupled to the key word dictionary 315. The key word dictionary 315 can comprise a set of key words as determined by system administrators, a technical support group (service agents) of the web service portal 115, selected members of the user community or combinations thereof. The terms of the key word dictionary 315 can be configured to provide a first level filter to determine whether a posted message contains content related to a new feature, a bug fix, or a complaint about existing feature for the selected product. The key word dictionary 315 can be implemented as part of a database, a linked list, or other data structure.

The control module 305 can be yet further coupled to the natural language processor 320. The natural language processor 320 can be configured to extract the text associated with either a new feature, a bug fix, or a complaint of an existing feature from the posted message. The natural language processor 320 can use latent semantic analysis or other similar natural language algorithms as known to those skilled in the art.

The control module 305 can also couple to a new feature list(s) 325. The new feature list 325 can be implemented as a graphical user interface such as a web page using HTML, XML or other mark-up language. Alternatively, the new feature list(s) 325 can exist in a database (not shown), a linked list or other data structure and then displayed as a graphical user interface.

Since the web service portal 115 can sell a variety of products, the control module 305 can maintain a respective new feature list 325 for an associated product. Similarly, the new feature list 325 can then be associated with a respective vendor 335 of the product.

Accordingly, the control module 305 can monitor the forums 330 for a posted message. For each message, the control module 305 can apply a key word search to the posted message using terms from the key word dictionary 315. The control module 305 can then determine a number of key word hits (i.e., a key word score), which is then compared to a predetermined key word threshold. If the key word score exceeds the key word threshold, there is strong likelihood that the posted message contains a desired feature, a complaint about an existing feature and/or bug fix.

The control module 305 can then apply the natural language processor 320 to the posted message to extract the content of the posted message as a feature comment. The control module 305 can then take the extracted feature comment and post the extracted feature comment as a desired feature on the new feature list 325. In some embodiments, the control module 305 can forward the extracted feature comment to a first available support staff (or service agent) for editing and/or approval to the new feature list. Alternatively, the control module 305 can forward a link to a web page that displays the extracted feature comment in an editable field. The service agent can then activate the link, review the extracted feature comment on the web page, edit the extracted content if necessary, and then submit the extracted feature comment to the control module 305 to post on the new feature list 325.

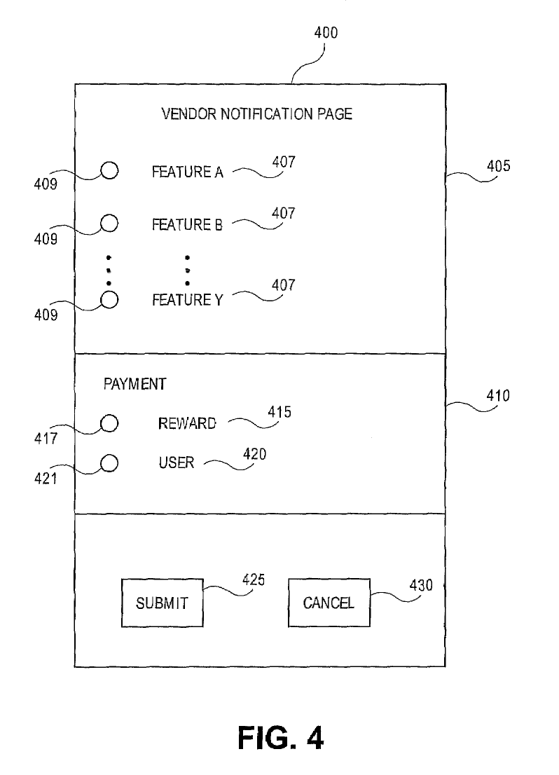

The new feature list 325 can then be made available to the respective vendor of the product by the control module 305. More particularly, the control module 305 can maintain a graphical page (e.g., a web page) for the new feature list 325. The control module 305 can notify the vendor when new desired features are posted on the new feature list 325. Alternatively, the control module 305 can forward a link to a vendor notification page to the respective vendor, which is shown in FIG. 4.

FIG. 4 illustrates an exemplary vendor notification page 400 in accordance with yet another embodiment. It should be readily apparent to those of ordinary skill in the art that the page 400 depicted in FIG. 4 represents a generalized schematic illustration and that other components may be added or existing components may be removed or modified.

As shown in FIG. 4, the vendor notification page 400 can comprise a feature section 405. The feature section 405 can display a list of respective feature listing in feature field 407. A feature selection widget 409 can be associated with each feature field 407. Accordingly, a vendor can select a feature to implement by activating the appropriate feature selection widget 409.

The vendor notification page 400 can also comprise a payment section 410. The payment section 410 can display two payment options for the vendor to implement any of the features displayed in the feature section 405. One payment option can be a reward field 415 with an associated reward selection widget 417. The second payment option can be a user field 420 with an associated user selection widget 421. Accordingly, a vendor can select the predetermined reward by activating the reward selection widget 417 as payment for implementing a selected feature in the feature section 405. Alternatively, the vendor can attempt to get payment from the user who posted the feature that is being implemented by activating user selection widget 421.

The vendor notification page 400 can further comprise a submit button 425 and a cancel button 430. The submit button 425 can be configured to take any selected features from the feature section 405 and selected payment option from the payment section 610 and forward these to the control module 305 when activated. The cancel button 430 can be configured to cease processing and close the vendor notification page when activated.

Returning to FIG. 3, the control module 305 can be configured to provide rewards for the vendor for developing any feature listed on the new feature list 325. For example, the control module 305 can use holiday packages as an incentive reward for developing a feature on the new feature list 325. Alternatively, the respective vendor 335 can contact the user or the user community to pay for a selected feature.

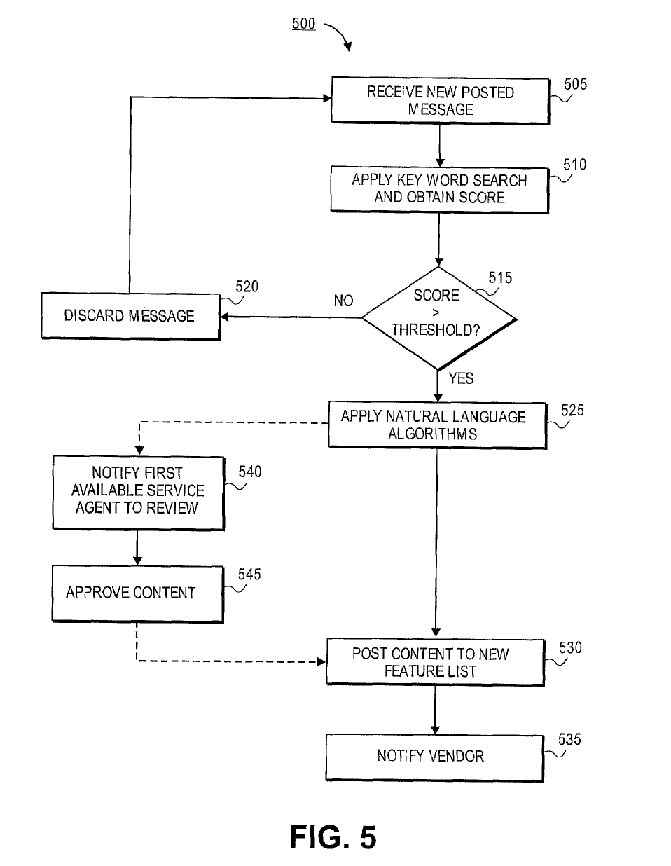

FIG. 5 illustrates a flow diagram 500 in accordance with yet another embodiment. It should be readily apparent to those of ordinary skill in the art that the flow diagram 500 depicted in FIG. 5 represents a generalized schematic illustration and that other steps may be added or existing steps may be removed or modified.

As shown in FIG. 5, the control module 305 can be configured to receive a new message that had been posted in one of the forums 330, in step 505. More particularly, the forums 330 can be configured to forward a copy of the posted message to the control module 305 in response to a user posting a message in a forum 330. The control module 305 can receive the posted message through the forum interface module 310 and buffer the posted message in a temporary buffer.

In step 510, the control module 305 can be configured to perform a key word search, in step 510. More specifically, the control module can parse the text of the posted message and compare each word in the text with the set of key words from the key word dictionary 315. Each term in the posted message that matches a key word term can count as a key word hit, where the key word hits are accumulated as key word score.

In step 515, the control module 305 can be configured to compare the key word score to a predetermined key word threshold. The predetermined key word threshold can act as a filter to determine whether the posted message contains information related to a new feature, a bug fix and/or complaint or negative comment regarding an existing feature.

If the key word score does not exceed the key word threshold, the control module 305 can cease processing of the posted message, in step 520. Subsequently, the control module 305 can return to the processing of step 505. Otherwise, the control module 305 can be configured to invoke the natural language processor 320 on the posted message, in step 525. The natural language processor 320 can be configured to extract a content or comment regarding new feature, bug fix or negative comment regarding an existing feature from the posted message. The natural language processor 320 can use latent semantic analysis or other similar natural language algorithms to extract the content from the posted message as a feature comment. The control module 305 can be configured to temporarily buffer the feature comment.

In step 530, the control module 305 can be configured to post the content to the appropriate new feature list 325 for the associated product. In step 535, the control module 305 can notify the associated vendor of product of the new listing on the new feature list 325. More specifically, the control module 305 can send an electronic message (e.g., electronic mail, instant message, etc.) with a link to the new feature list 325. Subsequently, the control module 305 can return to the processing of step 505.

In some embodiments, returning to step 530, the control module 305 can be configured to notify a first available service agent to review the feature comment, in step 540. More particularly, the control module 305 can send an electronic message to a service agent, who supports a help desk of the web service portal 115, to review the extracted content. The electronic message can contain a link to a service agent web page that displays the feature content in an editable field.

In step 545, the service agent can review and edit the extracted feature content if necessary. The service agent can then return the extracted feature comment to the control module 305 to process in step 535 by activating a submit button on the service agent web page.

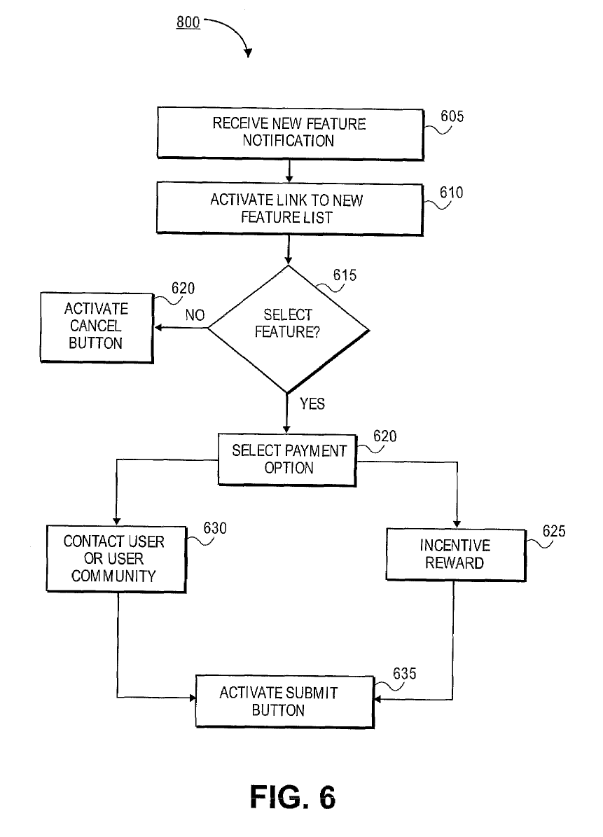

FIG. 6 illustrates a flow diagram 600 in accordance with yet another embodiment. It should be readily apparent to those of ordinary skill in the art that the flow diagram 600 depicted in FIG. 6 represents a generalized schematic illustration and that other steps may be added or existing steps may be removed or modified.

As shown in FIG. 6, a vendor 335 can be configured to receive a notification of a new feature from the web service portal 115, in step 605. More particularly, the vendor 335 can receive an electronic message that contains a link to the respective new feature list 325 on the vendor notification page 400.

In step 610, the vendor 335 can activate the link to display the new feature list 325 as the vendor notification page 400 on the web service portal 115. In step 615, the vendor can decide whether or not to implement a feature.

If the vendor 335 decides not to implement a feature by activating the cancel button 430, the vendor notification page 400 can be closed, in step 615. Otherwise, if the vendor does select a feature by activating the appropriate feature selection widget 409 associated with the selected feature 407, the vendor 335 can select a payment method for implementing the selected feature, in step 620.

The vendor 335 can select to redeem a predetermined reward by activating the rewards selection widget 417, in step 625. Otherwise, the vendor 335 can activate the user selection widget 421 for the suggesting user of the selected feature to pay for the implemented feature, in step 630. By selecting the user paid option, the control module 305 can send an electronic message to the user who posted the feature if he/she would be interested in paying for the requested feature. Either payment option is invoked when the vendor activates the submit button 425, in step 635.

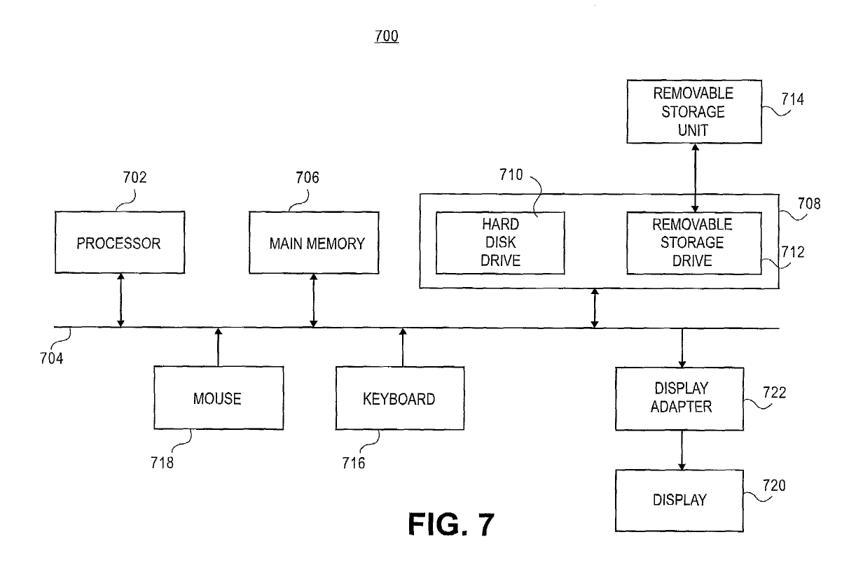

FIG. 7 illustrates an exemplary block diagram of a computing system 700 where an embodiment may be practiced. The functions of the feature module 120 may be implemented in program code and executed by a computing platform. The feature module 120 may be implemented in computer languages such as PASCAL, C, C++, JAVA, etc.

As shown in FIG. 7, the computer system 700 includes one or more processors, such as processor 702 that provide an execution platform for embodiments of the feature module 120. Commands and data from the processor 702 are communicated over a communication bus 704. The computer system 700 also includes a main memory 706, such as a Random Access Memory (RAM), where the feature module 120 may be executed during runtime, and a secondary memory 708. The secondary memory 708 includes, for example, a hard disk drive 710 and/or a removable storage drive 712, representing a floppy diskette drive, a magnetic tape drive, a compact disk drive, etc., where a copy of a computer program embodiment for the feature module 120 may be stored. The removable storage drive 712 reads from and/or writes to a removable storage unit 714 in a well-known manner. A user interfaces with the feature module 120 with a keyboard 716, a mouse 718, and a display 720. A display adapter 722 interfaces with the communication bus 704 and the display 720. The display adapter 722 also receives display data from the processor 702 and converts the display data into display commands for the display 720.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of developing features for a product, the method comprising:
monitoring a forum for messages;
parsing a newly posted message in the forum;
determining whether the newly posted message contains a new feature comment;
posting the new feature comment on a new feature list in response to the newly posted message contains a new feature comment.

2. The method of claim 1, wherein the parsing the newly posted message in the forum further comprises applying a key word search to the newly posted message.

3. The method of claim 2, further comprises ceasing processing of the newly posted message in response to the key word search not matching a predetermined key word search match threshold.

4. The method of claim 3, further comprising applying a latent semantic analysis to the newly posted message to determine a content of the newly posted message.

5. The method of claim 4, further comprising posting the content of the newly posted message to a new feature list.

6. The method of claim 5, further comprising:
associating the new feature list with a vendor; and
notifying the vendor in response to the posting of the content of the newly posted message to the new feature list.

7. The method of claim 6, further comprising providing a reward for the vendor to develop any feature on the new feature list.

8. The method of claim 6, further comprising receiving a request from the vendor for payment from an originator of the newly posted message.

9. An apparatus for developing features for a product, the apparatus comprising:
a forum interface adapted to monitor a forum;
a control module configured to couple with the forum interface;
a key word dictionary coupled to the control module, the key word dictionary comprising a set of key word terms; and
a natural language processor module configured to be couple with the control module, wherein the control module is configured to receive a new message posted in the forum through the forum interface; to determine whether the new message contains a new feature comment by applying a key word search using terms from the key word dictionary and the natural language processor module; and to post the new feature comment on a future feature list in response to the newly posted message containing the new feature comment.

10. The apparatus of claim 9, wherein the control module is further configured to cease processing of the new message in response to the key word search not matching a predetermined key word search match threshold.

11. The apparatus of claim 10, wherein the control module is further configured to determine a content of the newly posted message using the natural language processor module.

12. The apparatus of claim 10, wherein the control module is further configured to forward the content of the newly posted message to a first available service agent for approval.

13. The apparatus of claim 11, wherein the control module is further configured to post the content of the newly posted message to a new feature list.

14. The apparatus of claim 13, wherein the control module is further configured to associating the new feature list with a vendor and to notify the vendor in response to the posting of the content of the new message to the new feature list.

15. The apparatus of claim 14, wherein the control module is further configured to provide a reward for the vendor to develop any feature on the new feature list.

16. A system for developing features for a product, the system comprising:
a network configured to provide a communication channel for a plurality of users; and
a web service portal coupled to the network and configured to provide products and services to the plurality of users, wherein the web-service portal further comprises:
at least one forum associated with at least one product and service; and
a feature module coupled to the at least one forum, wherein the feature module is configured to monitor the at least one forum for messages; to parse a newly posted message in the at least one forum; to determine whether the newly posted message contains a new feature comment; and post the new feature comment on a new feature list in response to the newly posted message contains the new feature comment.

17. The system of claim 16, wherein the feature module is configured to apply a key word search to the new posted message.

18. The system of claim 17, wherein the feature module is configured to cease processing of the new posted message in response to the key word search not matching a predetermined key word search match threshold.

19. The system of claim 18, wherein the feature module is further configured to apply a latent semantic analysis to the new posted message to determine a content of the newly posted message.

20. The system of claim 19, wherein the feature module is further configured to post the content of the new posted message to a new feature list.

21. The system of claim 20, wherein the feature module is further configured to associate the new feature list with a vendor and to notify the vendor in response to the posting of the content of the new posted message to the new feature list.

22. The system of claim 21, wherein the feature module is further configured to provide a reward for the vendor to develop any feature on the new feature list.
